(19) United States
(12) Patent Application Publication
(10) Pub. No.: US 2024/0213454 A1
(43) Pub. Date: Jun. 27, 2024

(54) ELECTRODE PLATE FOR RECHARGEABLE BATTERY, MANUFACTURING METHOD THEREOF, AND RECHARGEABLE BATTERY USING THE SAME

(71) Applicant: SAMSUNG SDI CO., LTD., Yongin-si (KR)

(72) Inventors: Taeil LEE, Yongin-si (KR); Won-Gi AHN, Yongin-si (KR); Juhye BAE, Yongin-si (KR); Gwangwon PARK, Yongin-si (KR); Min-young JEONG, Yongin-si (KR)

(21) Appl. No.: 18/469,416

(22) Filed: Sep. 18, 2023

(30) Foreign Application Priority Data
Dec. 26, 2022 (KR) 10-2022-0184839

(51) Int. Cl. H01M 4/36; H01M 4/04; H01M 4/38; H01M 4/587

(52) U.S. Cl. CPC H01M 4/366; H01M 4/0404; H01M 4/0471; H01M 4/386; H01M 4/587

(57) ABSTRACT

An electrode plate includes an electrode current collector; a first active material layer in a pattern at the electrode current collector; and a second active material layer covering first active material layer and a portion of the electrode current collector. The electrode plate for a rechargeable battery may improve an impregnation characteristic of an electrolyte by inducing bending in a width direction of the electrode plate to improve rate capability.

### CROSS-REFERENCE TO RELATED APPLICATION

This application claims priority to and the benefit of Korean Patent Application No. 10-2022-0184839, filed in the Korean Intellectual Property Office on Dec. 26, 2022, the entire content of which is hereby incorporated by reference.

### BACKGROUND

### 1. Field

Embodiments of the present disclosure relate to an electrode plate for a rechargeable battery, a manufacturing method thereof, and a rechargeable battery utilizing the same.

### 2. Description of the Related Art

A rechargeable battery is a battery that can repeatedly perform charging and discharging, unlike a primary battery. Small-capacity rechargeable batteries are utilized in small, portable electronic devices, such as mobile phones, laptop computers, or camcorders. Large-capacity and high-density rechargeable batteries are utilized as power sources for driving motors of hybrid vehicles or electric vehicles, or as energy storage devices that can be, e.g., placed, in homes or in hybrid or electric vehicles.

A rechargeable battery includes an electrode assembly for charging and discharging a current, a case or a pouch for accommodating the electrode assembly and an electrolyte, and an electrode terminal connected to the electrode assembly drawing or extending (e.g., to draw power of the electrode assembly) out to the outside of the case or the pouch. The electrode assembly may be formed of a jelly roll type or kind formed by winding an electrode plate and a separator or a stack type or kind formed by stacking an electrode plate and a separator.

In order to improve characteristics of the electrode plate, different composites may be utilized in a thickness (e.g., a z-axis) direction of the electrode plate. The electrode plate has a characteristic effect in the thickness direction as well as a characteristic effect in a width (here, width may also be referred as length (e.g., an x- or y-axis) direction. Therefore, it is necessary to appropriately or su control the characteristic effects of the electrode plate in the thickness and width directions.

### SUMMARY

Aspects of one or more embodiments of the present disclosure are directed toward an electrode plate for a rechargeable battery that improves an impregnation characteristic of an electrolyte by inducing bending of the electrode plate in a width direction to improve rate capability, and a manufacturing method thereof.

Aspects of one or more embodiments embodiment of the present disclosure are directed toward a rechargeable battery including the electrode plate for the rechargeable battery and the manufacturing method thereof.

Additional aspects will be set forth in part in the description which follows and, in part, will be apparent from the description, or may be learned by practice of the presented embodiments of the disclosure.

An electrode plate for a rechargeable battery according to one or more embodiments of the present disclosure includes: an electrode current collector; a first active material layer in a pattern at the electrode current collector; and a second active material layer covering the first active material layer and a portion of the electrode current collector.

In one or more embodiments, the second active material layer may have a second roughness at a surface of the second active material layer when the second active material layer is dried, the second roughness being greater than a first roughness of the surface of the second active material layer when the second active material layer is coated.

In one or more embodiments, the first active material layer may have a trapezoidal cross-sectional structure (e.g., a trapezoidal shape in a cross-section taken along a plane defined by a z-axis and an x-axis or in a cross-sectional view).

In one or more embodiments, the first active material layer may include: a first width at a side of the electrode current collector; and a second width at a side of a surface of the second active material layer, the second width being less than the first width.

In one or more embodiments, the second active material layer may have a surface contact angle of 100° to 110° at a surface of the second active material layer.

A manufacturing method of an electrode plate for a rechargeable battery according to one or more embodiments of the present disclosure includes: preparing an electrode current collector; forming a first active material layer by coating a first active material slurry on the electrode current collector in a pattern; and forming a second active material layer by coating a second active material slurry on the first active material layer and the electrode current collector. The second active material layer has a (substantially) uniform thickness in a width direction of the electrode current collector.

In one or more embodiments, the forming of the first active material layer may further include drying the first active material layer, and forming the second active material layer may further include drying the second active material layer.

In one or more embodiments, the forming of the first active material layer and the forming of the second active material layer may proceed sequentially or concurrently (e.g., simultaneously).

A rechargeable battery according to one or more embodiments of the present disclosure may include a separator, a first electrode plate on one surface of the separator, and a second electrode plate on another surface of the separator opposite the one surface. At least one electrode plate of the first electrode plate or the second electrode plate may include: an electrode current collector; a first active material layer in a pattern on the electrode current collector; and a second active material layer covering the first active material layer and the electrode current collector.

In one or more embodiments, the second active material layer may have a second roughness at a surface of the second active material layer when the second active material layer is dried, the second roughness being greater than a first roughness of the surface of the second active material layer when the second active material layer is coated.

In one or more embodiments, the first active material layer may have a trapezoidal cross-sectional structure (e.g., a trapezoidal shape in a cross-section taken along a plane defined by a z-axis and an x-axis or in a cross-sectional view)).

In one or more embodiments, the first active material layer may include: a first width at a side of the electrode current collector; and a second width at a side of a surface of the second active material layer, the second width being less than the first width.

In one or more embodiments, the second active material layer may have a surface contact angle of 100° to 110° at a surface of the second active material layer.

One or more embodiments of the present disclosure may form (e.g., have) a first active material layer in a pattern at the electrode current collector and may form (e.g., have) a second active material layer at the first active material layer and the electrode current collector so that the embodiment(s) improve an impregnation characteristic of an electrolyte by inducing bending in a width direction of an electrode plate. Accordingly, one or more embodiments may improve rate capability by improving the impregnation characteristic of the electrolyte.

### BRIEF DESCRIPTION OF THE DRAWINGS

FIG. 1 is a cross-sectional view of an electrode plate for a rechargeable battery according to one or more embodiments of the present disclosure, and is a state diagram in which a first active material layer and a second active material layer are coated on an electrode current collector.

FIG. 2 is a cross-sectional view of the electrode plate of FIG. 1, according to one or more embodiments of the present disclosure, and is a cross-sectional view illustrating a state in which the first active material layer and the second active material layer coated on the electrode current collector are dried.

FIG. 3 is a plan view of the electrode plate of FIG. 2, according to one or more embodiments of the present disclosure.

FIG. 4 is a graph comparing impregnation rates of electrolytes for a Comparative Example and an Example according to an embodiment of the present disclosure.

FIG. 5 is a graph comparing a relationship between battery capacity and discharge rate for the Comparative Example and the Example.

FIG. 6 is a flowchart of a manufacturing method of the electrode plate for the rechargeable battery according to one or more embodiments of the present disclosure.

FIG. 7 is an exploded perspective view of the rechargeable battery according to one or more embodiments of the present disclosure.

FIG. 8 is an exploded perspective view of an electrode assembly applied to the rechargeable battery according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

The specific embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The drawings and description are to be regarded as illustrative in nature and not restrictive. In the drawings, the relative sizes of elements, layers, and regions may be exaggerated for clarity. Like reference numerals designate like elements throughout, and duplicative descriptions thereof may not be provided.

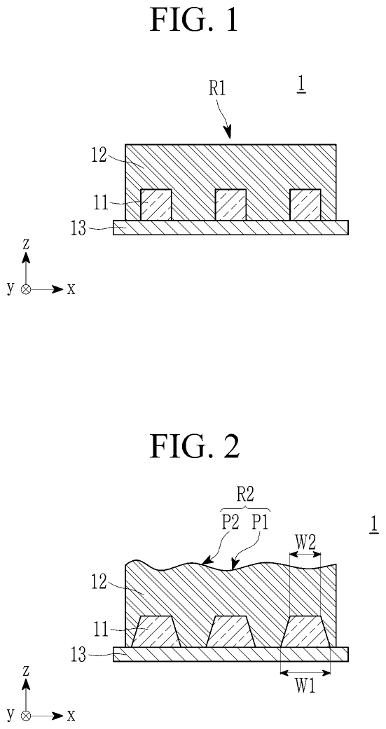

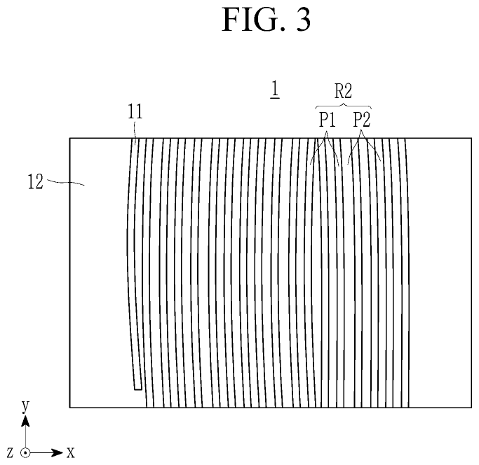

FIG. 1 is a cross-sectional view of an electrode plate for a rechargeable battery according to one or more embodiments of the present disclosure and is a state diagram in which a first active material layer and a second active material layer are coated on an electrode current collector, FIG. 2 is a cross-sectional view of the electrode plate of FIG. 1, according to one or more embodiments of the present disclosure, and is a cross-sectional view illustrating a state in which the first active material layer and the second active material layer coated on the electrode current collector are dried, and FIG. 3 is a plan view of the electrode plate for the rechargeable battery of FIG. 2, according to one or more embodiments of the present disclosure.

Referring to FIGS. 1 to 3, the electrode plate 1 for the rechargeable battery according to one or more embodiments includes the electrode current collector 13, the first active material layer 11, and the second active material layer 12. The electrode current collector 13 is formed of a thin metal plate.

A material constituting the electrode current collector 13 may be any material that does not react with lithium, does not form an alloy or a compound with lithium, and has conductivity (e.g., is a conductor). For example, the material may be a metal or an alloy. For example, the metal may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof. For example, the electrode current collector 13 may have a form of (e.g., a form selected from) a sheet, a foil, a film, a plate, a porous material, a mesoporous material, a through hole-containing material, a polygonal ring, a mesh, a foam, and/or a nonwoven fabric, but the present disclosure is not necessarily limited to the form, and any form utilized in the art may be utilized.

The first active material layer 11 is formed in a pattern (e.g., has a pattern or is patterned) on the electrode current collector 13. The first active material layer 11 is formed in a plurality of rows spaced apart in a width direction (an x-axis direction) at (or on) at least one surface of the electrode current collector 13, and is continuously formed in a longitudinal direction (a Y-axis direction) crossing the width direction.

After the first active material layer 11 is dried, the first active material layer 11 has a trapezoidal cross-sectional structure (e.g., a trapezoidal shape in a cross-section taken along a plane defined by a z-axis and an x-axis or in a cross-sectional view) in the electrode plate 1 for the rechargeable battery. For example, the first active material layer 11 is formed to have a first width W1 at a side of (or on a side of) the electrode current collector 13, and is formed to have a second width W2 less than the first width W1 at a side of (or on) a surface of the second active material layer 12.

The first active material layer 11 may include a negative electrode active material, a binder, and optionally a conductive material. A carbon-based active material or a silicon-based active material may be utilized as the negative electrode active material.

The carbon-based active material may be a carbon-containing active material generally utilized in a negative electrode, and may include crystalline carbon, amorphous carbon, or a combination thereof. An example of the crystalline carbon may include natural graphite or artificial graphite that has no-shape, or sheet, flake, spherical, or fiber shape, and an example of the amorphous carbon may include a soft carbon, a hard carbon, mesophase pitch carbide, fired coke, and/or the like.

For example, the silicon-based active material may include silicon, a silicon-carbon composite, SiOₓ (0<x<2), an Si-Q alloy (where Q is an element of (e.g., selected from the group consisting of) an alkali metal, an alkaline-earth metal, a group 13 element, a group 14 element, a group 15 element, a group 16 element, a transition metal, a rare earth element, and/or a combination thereof, and is not Si), and/or a combination thereof, and may be utilized by mixing at least one of these materials with SiO₂. The element Q may be an element of (e.g., selected from the group consisting of) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a combination thereof.

For example, the silicon-based active material may include a silicon-carbon composite including a silicon particle and a first carbon-based material. Here, the first carbon-based material may be crystalline carbon, amorphous carbon, or a combination thereof. If (e.g., when) the silicon-carbon composite is utilized as the silicon-based active material, a stable cycle characteristic may be implemented while exhibiting high capacity.

In the silicon-carbon composite including the silicon particle and the first carbon-based material, a content (e.g., amount) of the silicon particle may be 30 wt % to 70 wt %. For example, the content (e.g., amount) of the silicon particle may be 40 wt % to 50 wt %. A content (e.g., amount) of the first carbon-based material may be 70 wt % to 30 wt %. For example, the content (e.g., amount) of the first carbon-based material may be 60 wt % to 50 wt %. If (e.g., when) the content (e.g., amount) of the silicon particle and the content (e.g., amount) of the first carbon-based material are within the above ranges, high-capacity characteristics and an excellent or suitable lifespan characteristics may be exhibited.

In one or more embodiments, the silicon-based active material may include a silicon-carbon composite including a core in which a silicon particle and a second carbon-based material are mixed and a third carbon-based material around (e.g., surrounding) the core. The silicon-carbon composite may realize a very high capacity and at the same time may improve a capacity retention rate and a high-temperature lifespan characteristic of the battery.

The binder serves to attach (effectively attach) negative electrode active

material particles to each other and to attach (effectively attach) the negative electrode active material to the current collector. A non-aqueous binder, an aqueous binder, or a combination thereof may be utilized as the binder.

The non-aqueous binder may include an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polyepichlorohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

If (e.g., when) the aqueous binder is utilized as the binder, the aqueous binder may further include a thickener (that is, a cellulose-based compound capable of imparting viscosity). The cellulose-based compound may be utilized by mixing at least one of carboxymethyl cellulose, hydroxypropylmethyl cellulose, methyl cellulose, an alkali metal salt thereof, and/or the like. Na, K, or Li may be utilized as the alkali metal. A usage content (e.g., amount) of the cellulose-based compound may be 0.1 part by weight to 3 parts by weight with respect to 100 parts by weight of the negative electrode active material.

The conductive material may be utilized to impart conductivity to the electrode, and any conductive material that does not cause chemical change and is an electronic conductive material may be utilized in the battery. An example of the conductive material may be a conductive material including a carbon-based material such as natural graphite, artificial graphite, carbon black, acetylene black, ketjen black, a carbon fiber, and/or the like, a metal-based material such as a metal powder, a metal fiber, and/or the like of copper, nickel, aluminum, silver, and/or the like, a conductive polymer such as a polyphenylene derivative and/or the like, or a mixture thereof.

As an example, the first active material layer 11 includes the first active material with 95.40 wt % to 98.48 wt %, the conductive material with 0.027 wt % to 1.01 wt %, the thickener with 0.89 wt % to 1.01 wt %, and the binder with 1.20 wt % to 2.72 wt %. Deterioration in processability of the electrode plate 1 and a cell characteristic may occur if (e.g., when) the respective ratio is out of range.

When the second active material layer 12 is dried, the second active material layer 12 forms a second roughness R2 of FIGS. 2 and 3 greater than a first roughness R1 of FIG. 1 of a surface of the second active material layer 12 formed when the second active material layer 12 is coated. As an example, the second active material layer 12 includes the second active material with 95.40 wt % to 98.48 wt %, the conductive material with 0.027 wt % to 1.01 wt %, the thickener with 0.90 wt % to 1.01 wt %, and the binder with 0.40 wt % to 1.70 wt %. Deterioration in processability of the electrode plate 1 and a cell characteristic may occur if (e.g., when) the respective ratio is out of range.

For example, the first active material includes the carbon-based active material and the silicon-based active material, and the second active material layer 12 includes the carbon-based active material.

After the second active material layer 12 is dried, the second active material layer 12 forms a surface contact angle with 100° to 110° with respect to water at a surface of the second active material layer 12. In one or more embodiments, the surface of the second active material layer 12 may form the second roughness R2 to form a contact angle of 105° with respect to water.

In a comparative example in which the second roughness R2 is not formed, a surface of an active material layer of an electrode plate forms a contact angle of 95° to 100° with respect to water. In one or more embodiments, the surface of the active material layer of the comparative example may form a contact angle with 97°.

The second roughness R2 of the surface of the second active material layer 12 of one or more embodiments increases the contact angle. For example, the second roughness R2 increases the contact angle of the surface of the second active material layer 12 with respect to an electrolyte to improve an impregnation characteristic of the electrolyte with respect to the second active material layer 12 in a width direction (an x-axis direction) of the electrode plate 1 for the rechargeable battery.

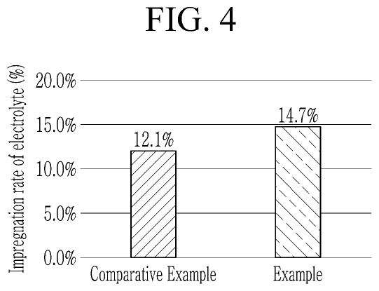

FIG. 4 is a graph comparing impregnation rates of electrolytes for a Comparative Example and an Example according to an embodiment of the present disclosure. Referring to FIG. 4, the surface of the active material layer of the Comparative Example forms the contact angle of 97º to have an electrolyte impregnation rate of 12.1%. In contrast, the surface of the second active material layer 12 of the Example forms the contact angle of 105° to have an electrolyte impregnation rate of 14.7%.

Due to a difference in the electrolyte impregnation rates, the electrode plate 1 for the rechargeable battery of the Example has a higher rate capability than the Comparative Example in the width direction (the x-axis direction).

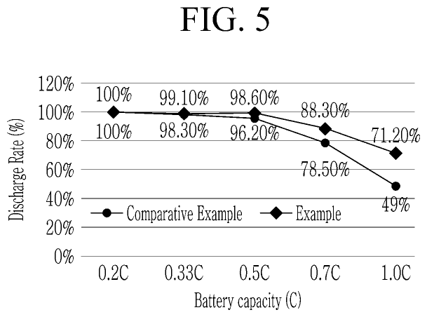

FIG. 5 is a graph comparing a relationship between a battery capacity and a discharge rate for the Comparative Example and the Example. Referring to FIG. 5, the surface of the active material layer of the Comparative Example has the discharge rate of 49% due to the electrolyte impregnation rate of 12.1% at 0.2 coulomb (C) discharge to 1.0 coulomb (C) discharge of the battery capacity.

In contrast, the surface of the second active material layer 12 of the Example has the discharge rate of 71.2% due to the electrolyte impregnation rate of 14.7% at 0.2 coulomb (C) discharge to 1.0 coulomb (C) discharge of the battery capacity. For example, the Example has improved rate capability because a drop in the discharge rate of the Example is less than that of the Comparative Example.

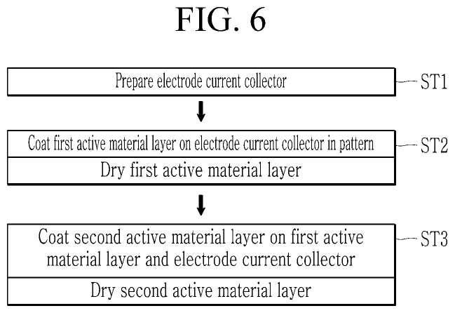

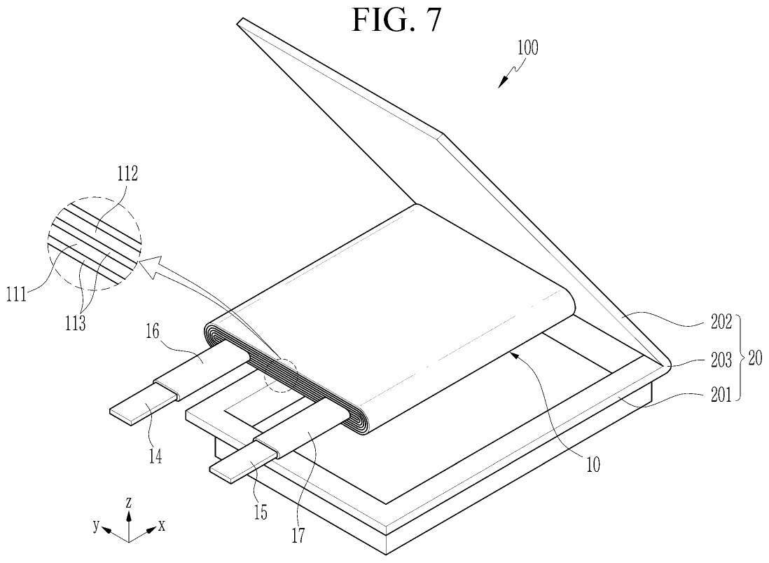

FIG. 6 is a flowchart of a manufacturing method of the electrode plate for the rechargeable battery according to one or more embodiments of the present disclosure. Referring to FIG. 6, the manufacturing method of the electrode plate for the rechargeable battery of one or more embodiments includes a first step (act or task) ST1, a second step ST2, and a third step ST3.

In the first step ST1, a thin electrode current collector 13 is prepared. The electrode current collector 13 may be formed of a copper or aluminum thin plate depending on whether it is a negative electrode current collector or a positive electrode current collector.

In the second step ST2, the first active material layer 11 is formed by coating a first active material slurry on the electrode current collector 13 in a pattern. The second step ST2 further includes a step of drying the first active material layer 11. In the drying step, the first active material layer 11 coated in the pattern is dried.

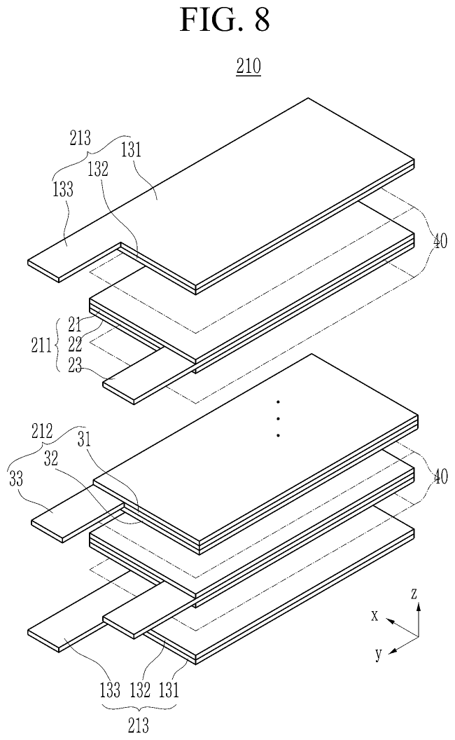

In one or more embodiments, the first active material layer 11 may be formed at one surface of the electrode current collector 13 (see a single-sided second electrode plate (or a single-surface second electrode plate) 213 of FIG. 8), or may be sequentially formed at (on) both (e.g., opposite) surfaces of the electrode current collector 13 (see first electrode plates 111 and 211 and second electrode plates 112 and 212 of FIGS. 7 and 8).

In the third step ST3, the second active material layer 12 is formed by coating a second active material slurry on the first active material layer 11 and the electrode current collector 13. In one or more embodiments, the second active material slurry is coated on the first active material layer 11 and a surface of the electrode current collector 13 at which the first active material layer 11 is not formed (e.g., where the pattern of the first active material layer 11 is not located).

Therefore, the first active material layer 11 and the second active material layer 12 are alternately formed in the width direction (the x-axis direction) at a portion adjacent to the surface of the electrode current collector 13. In one or more embodiments, a portion where the first active material layer 11 is provided forms a two-layer structure of the first and second active material layers 11 and 12. A portion where the first active material layer 11 is not provided forms a single layer structure of the second active material layer 12.

As the single layer structure and the two-layer structure are alternately disposed along the width direction (the x-axis direction) of the electrode current collector 13, the second active material layer 12 forms the second roughness R2 when the second active material layer 12 is dried greater than the first roughness R1 of a surface of the second active material layer formed when the second active material layer 12 is coated. As shown in FIG. 3, the second roughness R2 forms a concave portion P1 and a convex portion P2 on a surface of the second active material layer 12 depending on presence or absence, respectively, of the first active material layer 11.

The third step ST3 further includes a step of drying the second active material layer 12. In the drying step, the coated second active material layer 12 is dried. As described above, the second and third steps ST2 and ST3 in which the first active material slurry is coated and dried and then the second active material is coated and dried may be repeatedly performed. In one or more embodiments, in the second and third steps ST2 and ST3, the first and second active material slurries may be coated with a difference in coating time (e.g., when concurrently or simultaneously coated), and then they may be dried concurrently or at the same time.

Hereinafter, rechargeable batteries including the electrode plate 1 for the rechargeable battery according to one or more embodiments will be described. For convenience, a pouch type or kind rechargeable battery to which the electrode plate 1 for the rechargeable battery is applied will be described as an example. However, the present disclosure is not limited thereto, and the electrode plate 1 for the rechargeable battery according to one or more embodiments may be applied to a circular rechargeable battery and a prismatic rechargeable battery.

FIG. 7 is an exploded perspective view of the rechargeable battery according to one or more embodiments of the present disclosure. Referring to FIG. 7, the rechargeable battery 100 of one or more embodiments includes an electrode assembly 10 for charging and discharging an electric current, and a pouch 20 accommodating the electrode assembly 10 and an electrolyte.

The pouch 20 forms a sealing portion by thermally bonding outer edges of a first exterior portion 201 and a second exterior portion 202. The first and second exterior portions 201 and 202 are integrally connected by a rear connection portion 203 (e.g., to form a continuous body). Alternatively, the first and second exterior portions may be separately formed without the rear connection portion to be thermally bonded at outer edges of the first exterior portion and the second exterior portion.

The electrode assembly 10 is formed in a form of a jelly roll by disposing the

first electrode plate (referred to as a positive electrode plate for convenience) 111 and the second electrode plate (referred to as a negative electrode plate for convenience) 112 with a separator 113 interposed therebetween and winding the first electrode plate, the second electrode plate, and the separator (e.g., into the jelly roll). The electrode assembly 10 is formed flat (e.g., is flattened) by pressing a

side surface of the wound cylindrical shape. The electrode assembly 10 includes the positive electrode plate 111 and the negative electrode plate 112 to be drawn out of the pouch 20 through a first tab 14 and a second tab 15 provided at one side of a winding end surface. The first tab 14 and the second tab 15 are disposed at the sealing portion with insulating tapes 16 and 17 interposed therebetween.

The positive electrode plate 111 includes a coated portion at which a positive electrode active material is applied to an electrode current collector of a thin metal plate and an uncoated portion at which an electrode current collector is exposed by not applying the positive electrode active material. For example, the first tab 14 connected to the electrode current collector and the uncoated portion of the positive electrode plate 111 may be formed of aluminum (Al).

The negative electrode plate 112 includes a coated portion in which a negative electrode active material different from the active material of the positive electrode plate 111 is applied to an electrode current collector of a thin metal plate and an uncoated portion at which an electrode current collector is exposed by not applying the negative electrode active material. For example, the electrode current collector and the uncoated portion of the negative electrode plate 112 may be formed of copper (Cu), and the second tab 15 connected to the uncoated portion may be formed of nickel (Ni).

The electrode plate 1 for the rechargeable battery of FIGS. 1 to 3 may be applied to at least one of the positive electrode plate 111 or the negative electrode plate 112 of FIG. 7, and may be applied to the positive and negative electrode plates 111 and 112. For convenience, a structure of the electrode plate 1 for the rechargeable battery will be described by applying the structure of the electrode plate 1 to the positive and negative electrode plates 111 and 112.

Referring to FIGS. 1 to 3 and 7, the positive and negative electrode plates 111 and 112 include the first active material layer 11 formed in a pattern (e.g., has a pattern or is patterned) on the electrode current collector 13, and the second active material layer 12 covering the first active material layer 11 and the electrode current collector 13.

In the positive and negative electrode plates 111 and 112, when the second active material layer 12 is dried, the second active material layer 12 forms the second roughness R2 greater than the first roughness R1 of a surface of the second active material layer formed when the second active material layer 12 is coated.

The first active material layer 11 has a trapezoidal cross-sectional structure (e.g., a trapezoidal shape in a cross-section taken along a plane defined by a z-axis and an x-axis or in a cross-sectional view). The first active material layer 11 has the first width W1 at a side of (or on a side of) the electrode current collector 13 and the second width W2 less than the first width W1 at a side of (or on) a surface of the second active material layer 12.

The second active material layer 12 has a surface contact angle of 100° to 110° at a surface of the second active material layer 12.

In the negative electrode plate 112, the second roughness R2 of the surface of the second active material layer 12 increases the contact angle. For example, the second roughness R2 increases the contact angle of the surface of the second active material layer 12 with respect to the electrolyte to improve an impregnation characteristic of the electrolyte with respect to the second active material layer 12 in a width direction (an x-axis direction) of the negative electrode plate 112.

FIG. 8 is an exploded perspective view of an electrode assembly applied to the rechargeable battery according to one or more embodiments of the present disclosure. Referring to FIG. 8, the rechargeable battery 200 according to one or more embodiments forms a rechargeable battery by including an electrode assembly 210 in the pouch of FIG. 7 or in a case together with an electrolyte.

The electrode assembly 210 may include the first electrode plate (a positive electrode plate) 211 and the second electrode plate (a negative electrode plate) 212 that are formed as single sheets and are stacked with a separator 40 therebetween, and the single-sided second electrode plate (a single-sided negative electrode plate) 213 stacked at (on) at least one side of outermost sides in a stacking direction.

The first electrode plate (the positive electrode plate) 211 includes an active material layer 22 on both (opposite) surfaces of an electrode current collector plate 21. The electrode current collector plate 21 may include an uncoated portion 23 protruding to one side so that the uncoated portion 23 is connected to a tab drawn out of the pouch or the case when the rechargeable battery is assembled.

The second electrode plate (the negative electrode plate) 212 includes an active material layer 32 on both surfaces of an electrode current collector plate 31. The electrode current collector plate 31 may include an uncoated portion 33 protruding to one side so that the uncoated portion 33 is connected to a tab drawn out of the pouch or the case when the rechargeable battery is assembled. The uncoated portion 23 of the first electrode plate 211 and the uncoated portion 33 of the second electrode plate 212 may be drawn out in substantially the same direction, and may be spaced apart from each other in an x-axis direction.

The single-sided second electrode plate (the single-sided negative electrode plate) 213 is provided at (on) at least one side of upper and/or lower outermost sides of the electrode assembly 210. For convenience, and as an example, the present embodiment illustrates the electrode assembly 210 in which single-sided second electrode plates 213 (single-sided negative electrode plates) are provided at both upper and lower outermost sides of the electrode assembly 210.

The single-sided second electrode plate 213 may be disposed at one side of the first electrode plate (the positive electrode plate) 211 at both sides in the stacking direction with the separator 40 interposed therebetween. In one or more embodiments, the first electrode plate (the positive electrode plate) 211 and the single-sided second electrode plate 213 adjacent to each other in the stacking direction may be repeatedly stacked with the separator 40 interposed therebetween.

The single-sided second electrode plate 213 includes an active material

layer 132 on a single surface of an electrode current collector plate 131. Electrode current collector plates 131 may include uncoated portions 133 that protrude to one side and are spaced apart from each other so that the electrode current collector plates 131 are connected to tabs drawn out of the pouch or the case when the rechargeable battery is assembled.

The electrode plate 1 for the rechargeable battery of FIGS. 1 to 3 may be applied to at least one of the positive electrode plate 211, the negative electrode plate 212, and/or the single-sided negative electrode plate 213 of FIG. 8, and may be applied to the positive electrode plate 211, the negative electrode plate 212, and the single-sided negative electrode plate 213.

Referring to FIGS. 1 to 3 and 8, the active material layers 32, 22, and 132 of the positive and negative electrode plates 211 and 212 and the single-sided negative electrode plate 213 may be formed as the first active material layer 11 formed in a pattern (e.g., has a pattern or is patterned) on the electrode current collector 13, and the second active material layer 12 covering the first active material layer 11 and the electrode current collector 13.

In the active material layers 32, 22, and 132 of the positive and negative electrode plates 211 and 212 and the single-sided negative electrode plate 213, when the second active material layer 12 is dried, the second active material layer 12 forms the second roughness R2 greater than the first roughness R1 of a surface of the second active material layer formed when the second active material layer 12 is coated.

The first active material layer 11 has a trapezoidal cross-sectional structure (e.g., a trapezoidal shape in a cross-section taken along a plane defined by a z-axis and a x-axis or in a cross-sectional view). The first active material layer 11 has the first width W1 at a side of (or on a side of) the electrode current collector 13 and the second width W2 less than the first width W1 at a side of (or on) a surface of the second active material layer 12.

In the active material layers 32, 22, and 132 of the positive and negative electrode plates 211 and 212 and the single-sided negative electrode plate 213, the first active material layer 11 includes the first active material with 97.35 wt %, the conductive material with 0.05 wt %, the thickener with 0.9 wt %, and the binder with 1.7 wt %, and the first active material includes graphite and a silicon-carbon nanocomposite (SCN) material.

The second active material layer 12 includes the first active material with 97.35 wt %, the conductive material with 0.05 wt %, the thickener with 0.9 wt %, and the binder with 1.7 wt %, and the second active material includes graphite. The second active material layer 12 has a surface contact angle of 100° to 110° at a surface of the second active material layer 12.

In the active material layers 32, 22, and 132 of the positive and negative electrode plates 211 and 212 and the single-sided negative electrode plate 213, the second roughness R2 of the surface of the second active material layer 12 increases the contact angle. For example, the second roughness R2 increases the contact angle of the surface of the second active material layer 12 with respect to the electrolyte to improve an impregnation characteristic of the electrolyte with respect to the second active material layer 12 in a width direction (an x-axis direction) of the positive and negative electrode plates 211 and 212 and the single-sided negative electrode plate 213.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “lower,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on” or “connected to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be further understood that the terms “comprises,” “comprising,” “includes,” “including,” “have,” and “having” when used in this specification, specify the presence of the stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

As used herein, the singular forms “a”, “an” and “the” are intended to include the plural forms as well, unless the context clearly indicates otherwise.

Further, the use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### REFERENCE NUMERALS

| | |
|---|---|
| 1: electrode plate for rechargeable | |
| battery | |
| 10, 210: electrode assembly | |
| 11: first active material layer | 12: second active material layer |
| 13: electrode current collector | 14: first tab |
| 15: second tab | 16, 17: insulating tape |
| 20: pouch | 21, 31, 131: electrode current |
| | collector plate |
| 22, 32, 132: active material layer | 23, 33, 133: uncoated portion |
| 40, 113: separator | 100, 200: rechargeable battery |
| 111, 211: first electrode plate | |
| (positive electrode plate) | |
| 112, 212: second electrode plate | |
| (negative electrode plate) | |
| 201: first exterior portion | 202: second exterior portion |
| 203: rear connection portion | |
| 213: single-sided second electrode | |
| plate (single-sided negative electrode | |
| plate) | |
| R1: first roughness | R2: second roughness |
| W1: first width | W2: second width |

What is claimed is:

1. An electrode plate for a rechargeable battery, the electrode plate comprising:
an electrode current collector;
a first active material layer in a pattern at the electrode current collector; and
a second active material layer covering the first active material layer and a portion of the electrode current collector.

2. The electrode plate of claim 1, wherein the second active material layer has a second roughness at a surface of the second active material layer when the second active material layer is dried, the second roughness being greater than a first roughness of the surface of the second active material layer when the second active material layer is coated.

3. The electrode plate of claim 1, wherein the first active material layer has a trapezoidal shape in a cross-sectional view.

4. The electrode plate of claim 1, wherein the first active material layer comprises:
a first width at a side of the electrode current collector; and
a second width at a side of a surface of the second active material layer, the second width being less than the first width.

5. The electrode plate of claim 1, wherein the second active material layer has a surface contact angle of 100° to 110° at a surface of the second active material layer.

6. A manufacturing method of an electrode plate for a rechargeable battery, the method comprising:
preparing an electrode current collector;
forming a first active material layer by coating a first active material slurry on the electrode current collector in a pattern; and
forming a second active material layer by coating a second active material slurry on the first active material layer and the electrode current collector,
wherein the second active material layer has a substantially uniform thickness in a width direction of the electrode current collector.

7. The manufacturing method of claim 6, wherein the forming of the first active material layer further comprises drying the first active material layer, and the forming of the second active material layer further comprises drying the second active material layer.

8. The manufacturing method of claim 6, wherein the forming of the first active material layer and the forming of the second active material layer proceed sequentially or concurrently.

9. A rechargeable battery comprising:
a separator,
a first electrode plate on one surface of the separator, and
a second electrode plate on another surface of the separator opposite the one surface,
wherein at least one electrode plate of the first electrode plate or the second electrode plate comprises:
an electrode current collector;
a first active material layer in a pattern on the electrode current collector; and
a second active material layer covering the first active material layer and the electrode current collector.

10. The rechargeable battery of claim 9, wherein the second active material layer has a second roughness at a surface of the second active material layer when the second active material layer is dried, the second roughness being greater than a first roughness of the surface of the second active material layer when the second active material layer is coated.

11. The rechargeable battery of claim 9, wherein the first active material layer has a trapezoidal shape in a cross-sectional view.

12. The rechargeable battery of claim 9, wherein the first active material layer comprises:
a first width at a side of the electrode current collector; and
a second width at a side of a surface of the second active material layer, the second width being less than the first width.

13. The rechargeable battery of claim 9, wherein the second active material layer has a surface contact angle of 100° to 110° at a surface of the second active material layer.
